(19) United States
(12) Patent Application Publication
(10) Pub. No.: US 2008/0069554 A1
(43) Pub. Date: Mar. 20, 2008

(54) Lens driving device

(76) Inventor: Shih-Hsien Huang, Taichung City (TW)

Correspondence Address: Shih-Hsien Huang, 235 Chung - Ho, Box 8-24, Taipei, omitted

(21) Appl. No.: 11/522,812

(22) Filed: Sep. 18, 2006

(51) Int. Cl. G03B 3/10

(52) U.S. Cl. 396/133

(57) ABSTRACT

The retaining seat has a receiving space for receiving the driven seat; and the receiving space being installed with a coil set; the coil set having at least one coil and at least one magnetic block. The driven seat is installed with magnetic units corresponding to the coil set; the driven seat can move along a predetermined track in the receiving space of the retaining seat. The driven seat has two magnetic units which are installed at a left side and a right side of the driven seat or at an upper and a lower side of the driven seat. The magnetic units of the driven seat are installed at an upper and a lower side of the driven seat. The lens driving device provides a larger receiving space for receiving a great or more coils. Thus when no power is applied, the driven seat can still be positioned.

### FIELD OF THE INVENTION

The present invention relates to lenses, in particular to a lens driving device which provides a larger receiving space for receiving a great or more coils. Thus when no power is applied, the driven seat can still be positioned.

### BACKGROUND OF THE INVENTION

A video recorder, such as a camera, recorders images through a tape, a film or a light sensing elements. The lens of the camera serves to control input light. The driving unit is used to calibrate the light inputted. In the prior art, the driving unit is a mechanic device, however electronic driving unit is developed so that the driving unit is more stable and accurate and can be operated easily.

In one prior art, the driving unit has two magnetic units of different magnetic poles being installed in the retaining seat. The two magnetic units are installed at in the inner left and inner right sides of the retaining seat. A coil winds around the driven seat. When current flows through the coil of the driven seat, the magnetic field will interact with the magnetic unit of the retaining seat so as to control the driven seat to move to a position to be adjusted. The direction of the current of the coil serves to control the magnetic field of the driven seat. Thus a driving device is got.

However above mentioned prior art has the following disadvantages.

The space of the driven seat for receiving the coil is limited. Thus a great current is necessary for generating a proper magnetic field. Power is wasted and the standby time and operation time period of the camera is reduced. Furthermore, the material of the coil is made of copper which is not a fiber material. When the power of the coil is interrupted, it is not affected by the magnetic field of the coil. Thus the driven seat moves in the retaining seat so as to reduce the lifetime of the product.

### SUMMARY OF THE INVENTION

Accordingly, the primary object of the present invention is to provide a lens driving device which provides a larger receiving space for receiving a great or more coils. Thus when no power is applied, the driven seat can still be positioned.

To achieve above objects, the present invention provides a lens driving device having a retaining seat and a driven seat. The retaining seat has an receiving space for receiving the driven seat; and the receiving space is installed with a coil set; the coil set has at least one coil and at least one magnetic block. The driven seat is installed with magnetic units corresponding to the coil set; the driven seat can move along a predetermined track in the receiving space of the retaining seat. The driven seat has two magnetic units which are installed at a left side and a right side of the driven seat. The driven seat has two magnetic units which are installed at an upper and a lower side of the driven seat. The magnetic units of the driven seat are installed at an upper and a lower side of the driven seat. The magnetic block is a flat plate; and the coil winds around the magnetic block along a helical path. Or the magnetic block is a flat plate; and a winding shaft protrudes from the magnetic block; and the coil winds around the winding shaft.

The various objects and advantages of the present invention will be more readily understood from the following detailed description when read in conjunction with the appended drawing.

### BRIEF DESCRIPTION OF THE DRAWINGS

FIG. 1 is an exploded perspective view of the lens driving device of the present invention.

FIG. 2 is a schematic perspective view of the lens driving device of the present invention.

FIG. 3 is a schematic view of the lens driving device of the present invention.

FIG. 4 is a cross sectional view along line A-A in FIG. 3 of the present invention.

FIG. 5 is a cross sectional view along line B-B of FIG. 3 of the present invention.

FIGS. 5a to 5d are schematic views showing that the driven seat of the present invention is moved to the left side.

FIG. 6 is a schematic cross sectional view showing the movement of the driven seat of the present invention.

FIGS. 6a to 6d are schematic view showing that the driven seat of the present invention is moved to the right side.

FIG. 7 is a schematic view showing that the driven seat of the present invention is positioned at a left side.

FIG. 8 is a schematic view showing that the driven seat of the present invention is positioned at a right side.

FIG. 9 is an assembled schematic view of the driven seat and the magnetic units of the second embodiment of the present invention.

FIG. 10 is a schematic view about the second embodiment of the present invention.

FIG. 11 is an assembled schematic view of the magnetic units and the driven seat of the third embodiment of the present invention.

FIG. 12 is a schematic perspective view about the driven seat in the third embodiment of the present invention.

FIG. 13 is an assembled schematic view of the third embodiment of the present invention.

FIG. 14 is an exploded perspective view of the fourth embodiment of the present invention.

FIG. 15 is an assembled schematic view about the fourth embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

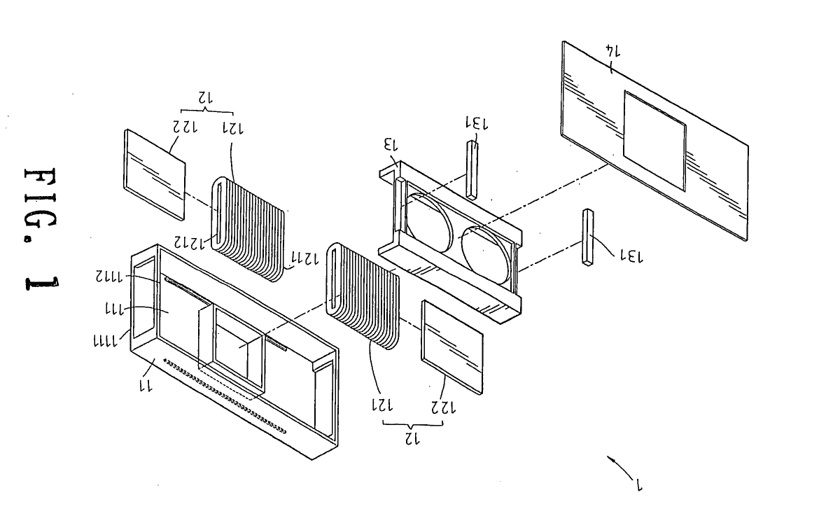

Referring to FIGS. 1 to 3, the lens driving device of the present invention is illustrated. The present invention has the following elements.

A driving unit 1 has a retaining seat 11 a coil set 12, a driven seat 13 and a cover 14. In the present invention, the driving unit 1 is a light filtering sheet, but it is not used to confine the scope of the present invention.

The retaining seat 11 is an oblong box with a receiving space 111 therein. The receiving space 111 has a closing end 1111 and an opening end 1112 for receiving the coil set 12 and the driven seat 13. By using the cover 14, the coil set 12 and the driven seat 13 can be confined in the receiving space 111. Here, we define that the closing end 1111 is at a front end and the opening end 1112 is at a rear end. The two long sides of the receiving space 111 are a left side and a right side.

The coil set 12 has at least one coil 121 and a magnetic block 122. The magnetic block 122 is a flat plate. The coil 121 is wound along a spiral path. When current is conducted, the first end 1211 and second end 1212 thereof are formed as different magnetic poles. The first end 1211 and second end 1212 of the coil 121 are at the right side and left sides. The coil 121 is positioned in the receiving space 111.

The driven seat 13 is received in the receiving space 111 of the retaining seat 11. The driven seat 13 can move leftwards and rightwards along the receiving space 111. Each of a left and a right side of the driven seat 13 is installed with a magnetic unit 131. The positions of the two magnetic units 131 are corresponding to those of the first end 1211 and second end 1212 of the coil set 12. One pole of the magnetic unit 131 faces the coil set 12 and another pole thereof is at the backside of the pole facing the coil set 12.

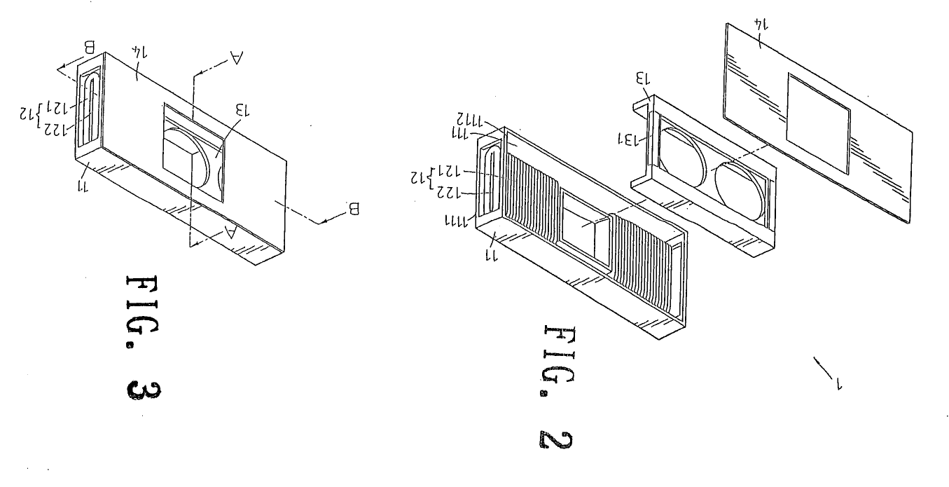

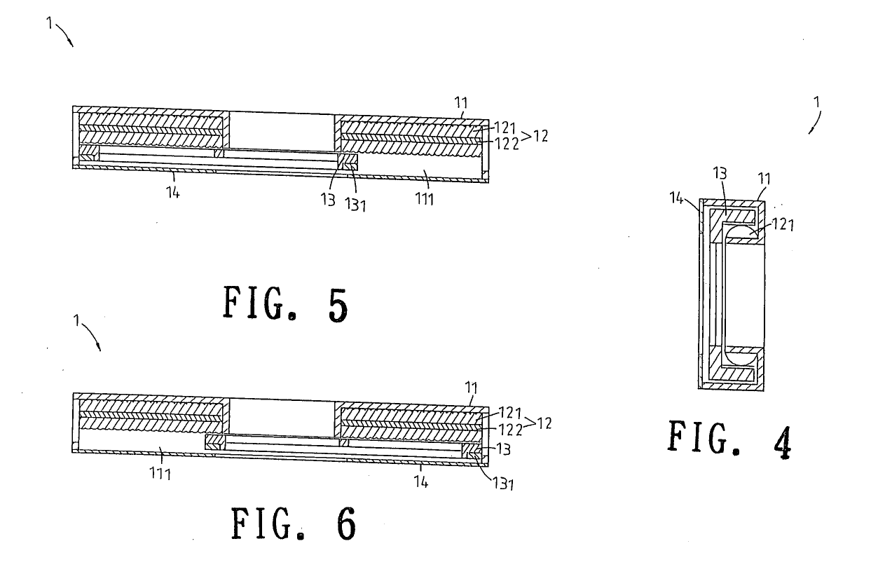

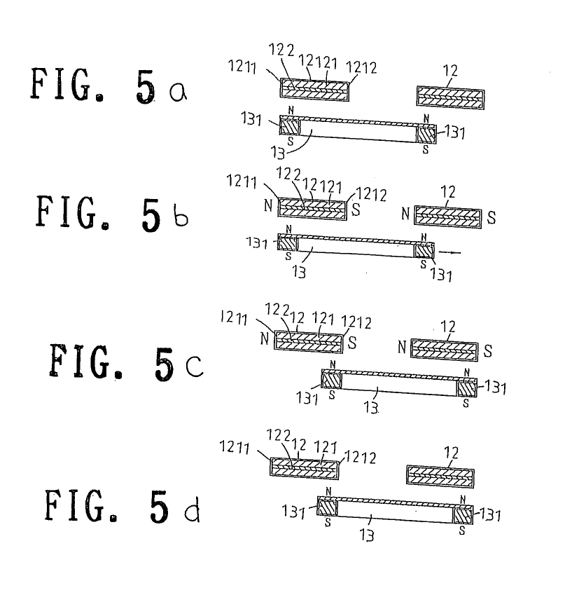

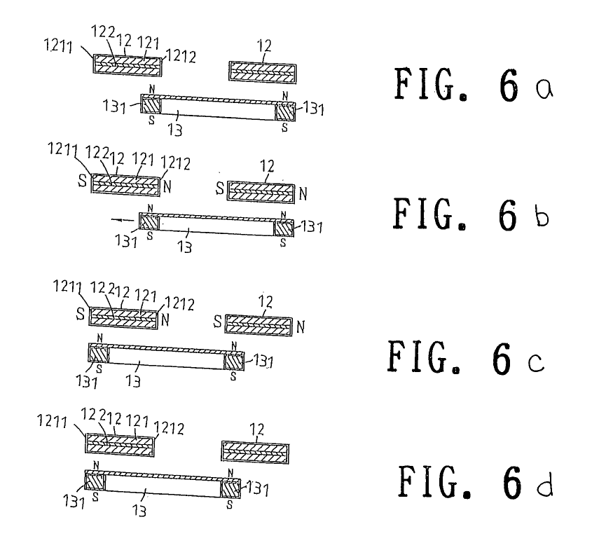

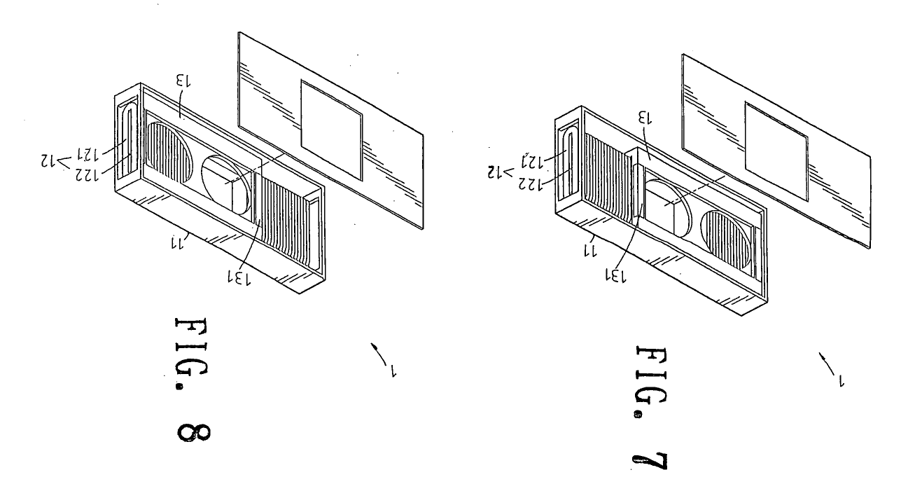

After installation, referring to FIGS. 3 to 6, the two coils 121 and magnetic blocks 122 are installed at the left and right sides of the receiving space 111 of the retaining seat 11. The magnetic units 131 of the driven seat 13 are corresponding to the first end 1211 or second end 1212 of the coil set 12. The opening end 1112 of the receiving space 111 of the retaining seat 11 is sealed by the cover 14 so that all the elements are confined within the receiving space 111. When the coil 121 of the coil set 12 is conducted, the magnetic units 131 of the driven seat 13 are affected by the coils 121. The driven seat 13 will displace leftwards or rightwards along the receiving space 111, as illustrated in FIGS. 5 and 6. Thus it has the affect of adjustment of positions.

Referring to FIGS. 5a to 5d and 6a to 6d, FIGS. 5a to 5d shows that the driven seat 13 moves from the left side illustrated in FIG. 5 to the right side illustrated in FIG. 6. FIGS. 6a to 6d shows that the driven seat 13 moves from the right side illustrated in FIG. 6 to the left side illustrated in FIG. 5. However in these drawings, the drawings are simplified. Only the coil set 12, the driven seat 13 and the magnetic units 131 are illustrated. The gaps between elements are enlarged for description.

In FIG. 5a, the coil 121 of the coil set 12 is not conducted and thus no magnetic field generates. At this moment, the driven seat 13 attracts the magnetic block 122 by the magnetic field of the magnetic unit 131 so that the driven seat 13 is positioned at the left side.

In FIG. 5b, the coils 121 of the coil set 12 is conducted, magnetic field is generated. The first end 1211 of the coil 121 is N pole and the second end 1212 is an S pole. The N pole of the first end 1211 is near the N pole of the magnetic unit 131 and thus they are repulsive. The driven seat 13 moves rightwards along the direction illustrated by an arrow. p

Referring to FIG. 5c, the coils 121 of the coil set 12 are conducted along the direction illustrated in FIG. 5b, the driven seat 13 will move rightwards gradually. The N pole of the magnetic units 131 of the driven seat 13 is near the S poles of the coils 121. Thus it is attracted by the driven seat 13 to move rightwards to the inner right side of the receiving space 111.

Referring to FIG. 5d, the coils 121 of the coil set 12 is non-conducted. The magnetic units 131 of the driven seat 13 is attracted by the magnetic blocks 122 of the coil set 12 and thus is positioned therein.

Referring to FIG. 6a, the state in FIG. 6a is identical to that of FIG. 5d.

In FIG. 6b, the coils 121 of the coil set 12 are conducted with currents along reverse directions of those in FIG. 5b. The first end 1211 of the coil 121 is an S pole and the second end 1212 there of is an N pole. The N pole of the second end 1212 of the coil 121 is near the N pole of the magnetic unit 131. Thus they are repulsive and the driven seat 13 moves leftwards along a direction illustrated by the arrow.

In FIG. 6c, the coil 121 of the coil set 12 is conducted by a current the direction of which is identical to that in FIG. 6b. The driven seat 13 moves leftwards gradually. The N pole of the magnetic unit 131 of the driven seat 13 is near the S pole of the coil 121. They are attractive to one another so that the driven seat 13 moves leftwards to the inner left side of the receiving space 111.

In FIG. 6d, the power of the coils 121 of the coil set 12 have been interrupted, but the magnetic units 131 of the driven seat 13 are attractive to the magnetic blocks 122 of the coil set 12 and thus it still in the position.

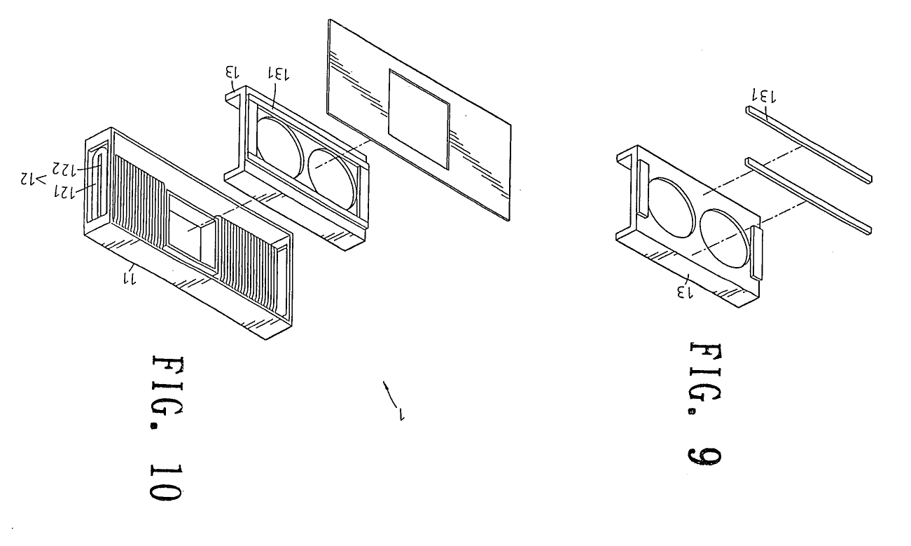

From above mentioned FIGS. 5a to 5d and 6a to 6d, in the present invention, the current flows through the coils 121 so as to generate magnetic field and the driven seat 13 moves to the inner left side of the receiving space 111 (referring to FIG. 7) or right side of the receiving space 111 (referring to FIG. 8) so as to achieve the object of adjustment. Moreover, when no current and thus no magnetic field in the coils 121 of the coil set 12, the magnetic block 122 can still be attractive by the magnetic unit 131 of the driven seat 13 so that the driven seat 13 will not slide randomly in the receiving space 111.

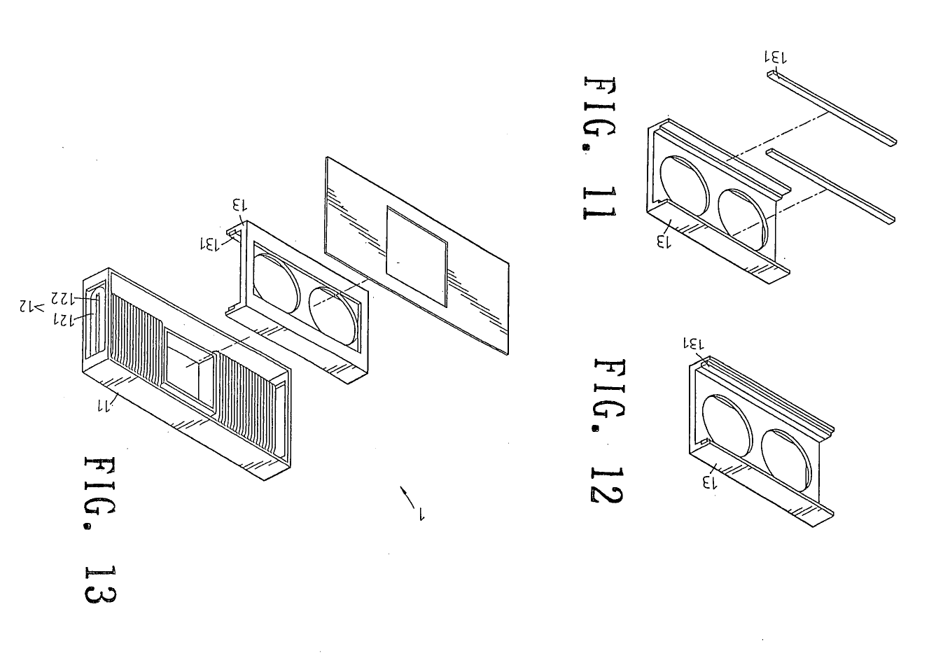

Referring to FIGS. 9 and 10, the second embodiment of the present invention is illustrated. In the following those identical to the first embodiment will not be described herein. Only those difference are described.

In FIG. 9, the magnetic unit 131 of the driven seat 13 is installed in the upper side or lower side of the driven seat 13. In this embodiment, there are two magnetic units 131. The left sides of the two magnetic units 131 have the same magnetic poles and the right sides of the two magnetic units 131 have the same magnetic poles. Thus the driven seat 13 can be driven by the coil set 12.

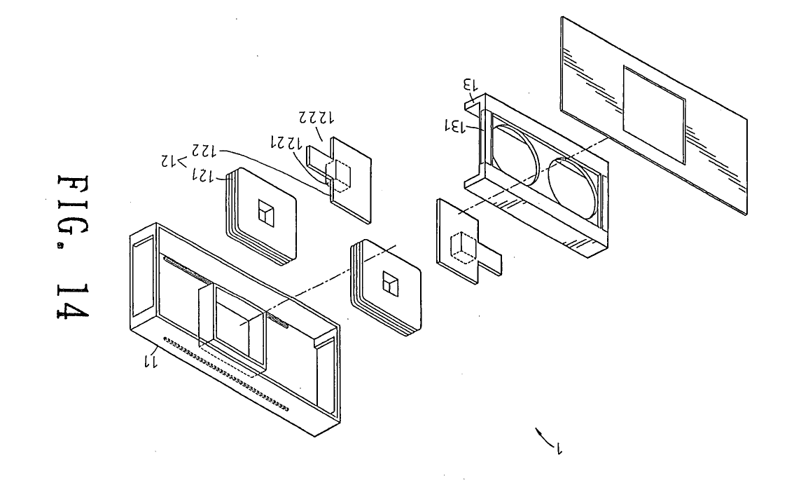

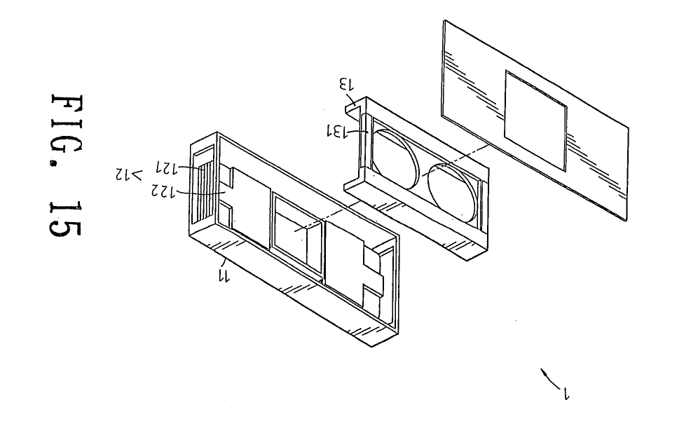

Referring to FIGS. 11 to 13, the third embodiment of the present invention is illustrated. In the following those identical to the first embodiment will not be described herein. Only those difference are described.

Referring to FIG. 11, the magnetic units 131 of the driven seat 13 are installed at the upper and lower sides of the coils 121. The left sides of the two magnetic units 131 have the same magnetic poles and the right sides of the two magnetic units 131 have the same magnetic poles. Thu's the driven seat 13 can be driven.

Referring to FIGS. 14 and 15, the fourth embodiment of the present invention is illustrated. In the following those identical to the first embodiment will not be described herein. Only those difference are described.

The magnetic block 122 has a form of a T shape. A winding shaft 1221 is protruded from a center portion of the magnetic block 122. The coil 121 is wound around the winding shaft 1221. The notches 1222 in the T shape magnetic block 122 have the advantage of driving the driven seat 13 by the coil set 12 as the coil 121 is conducted.

In the present invention, the coil set 12 having the magnetic blocks 122 is fixed in the retaining seat 11. The magnetic units 131 installed on the driven seat 13 make the coil set 12 having more space for installing the windings of the coil 121 and the magnetic block 122 having the effect of positioning the magnetic unit 131 as no current is applied. The installation of the coil set 12 and the magnetic units 131 are not limited in above mentioned four embodiments. Other ways for installing the coil set 12 having magnetic blocks 122 in the retaining seat 11, installing the magnetic units 131 of the driven seat 13 and arranging the magnetic units 131 are also within the scope of the present invention.

In the present invention, the driving unit 1 can be used in camera, video recorder, monitor, etc. which have lenses.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A lens driving device having a retaining seat and a driven seat;
wherein the retaining seat has an receiving space for receiving the driven seat; and the receiving space is installed with a coil set; the coil set has at least one coil and at least one magnetic block;
the driven seat is installed with magnetic units corresponding to the coil set; the driven seat can move along a predetermined track in the receiving space of the retaining seat.

2. The lens driving device as claimed in claim 1, wherein the driven seat has two magnetic units which are installed at a left side and a right side of the driven seat.

3. The lens driving device as claimed in claim 1, wherein the driven seat has two magnetic units which are installed at an upper and a lower side of the driven seat.

4. The lens driving device as claimed in claim 1, wherein the magnetic units of the driven seat are installed at an upper and a lower side of the driven seat.

5. The lens driving device as claimed in claim 1, wherein the magnetic block is a flat plate; and the coil winds around the magnetic block along a helical path.

6. The lens driving device as claimed in claim 1, wherein the magnetic block is a flat plate; and a winding shaft protrudes from the magnetic block; and the coil winds around the winding shaft.

7. The lens driving device as claimed in claim 6, wherein the magnetic block has at least one notch.

8. The lens driving device as claimed in claim 1, wherein one magnetic pole of the magnetic unit faces to the coil set and another magnetic pole is far away from the coil set.

9. The lens driving device as claimed in claim 1, wherein the coil of the coil set generates magnetic field when the coil is conductive; when the power is interrupted, the magnetic block and the magnetic unit are attractive to one another so that the driven seat can be retained at a predetermined position.

10. The lens driving device as claimed in claim 1, wherein the driving unit is used for driving a light filter sheet.
